(19) United States
(12) Patent Application Publication
(10) Pub. No.: US 2020/0100497 A1
(43) Pub. Date: Apr. 2, 2020

(54) SAFENERS AND FORMULATIONS CONTAINING SAFENERS, BIOCIDES AND INOCULANTS

(71) Applicant: Bayer CropScience LP, St. Louis, MO (US)

(72) Inventors: Tai-Teh WU, Chapel Hill, NC (US); Duy LE, Cary, NC (US); Wade HOLCOMBE, Hillsborough, NC (US); Jian ZHANG, Durham, NC (US); Steven NUTTER, Bahama, NC (US); Gary CHRISTENSEN, Morrisville, NC (US)

(21) Appl. No.: 16/621,159

(22) PCT Filed: Jun. 8, 2018
(86) PCT No.: PCT/US2018/036657

§ 371 Date: Dec. 10, 2019

Related U.S. Application Data
(60) Provisional application No. 62/518,056, filed on Jun. 12, 2017.

(51) Int. Cl. A01N 25/32; A01N 47/24; A01N 51/00

(52) U.S. Cl. CPC A01N 25/32; A01N 51/00; A01N 47/24

(57) ABSTRACT

Safeners are provided which reduce the toxicity of biocide-containing pesticide formulations on microbial inoculants. The safeners of the invention comprise a sulfite, such as sodium bisulfite and/or a hydrazine. The safeners of the invention optionally further comprise an amine, such as N,N-dimethylamine. Pesticidal formulations comprising a pesticide, a biocide and a safener of the invention are also provided. Methods of using the safeners and pesticidal formulations of the invention to treat plants are further provided.

### BACKGROUND

### 1. Field

The present disclosure relates to the development of safeners to enable co-application of formulations containing biocides, such as insecticides, and inoculants.

### 2. Description of Related Art

Many microorganisms are known to exert beneficial effects on plant growth. For example, legumes have the ability to form a mutually beneficial (symbiotic) relationship with Rhizobium bacteria. The benefit to the plant, and thus to the grower, is that these bacteria can take (fix) nitrogen from the air (in soil spaces) and make it available to the plant via symbiotic nitrogen fixation.

Inoculation of plants by application of beneficial microorganisms to soil and/or seed is widely used in agriculture to improve crop growth. However, microbial inoculants, particularly Rhizobium, are sensitive to biocides. This severely limits the ability to treat seed with biocide-containing formulations, such as formaldehyde-containing insecticides, and inoculants since the biocide negatively affects the viability of the inoculant.

Accordingly, there is a need to develop safeners that enable co-application of formulations containing biocides, such as insecticides containing formaldehyde, and inoculants.

The solution to this technical problem is provided by the embodiments characterized in the claims.

### BRIEF SUMMARY

The present application provides safeners that reduce the toxicity of biocide-containing pesticide formulations on microbial inoculants. In some embodiments, the safeners of the invention comprise a sulfite, such as sodium bisulfite. In an additional embodiment, the safeners of the invention comprise a sulfite and an amine, such as N,N-dimethylamine. In other embodiments, the safener comprises a hydrazine, such as phenylhydrazine.

The present application also provides formulations comprising one or more pesticides, one or more biocides, and a safener that reduces the toxicity of the biocide. In some embodiments, the pesticide contains one or more thio-N carbamoyl functional groups. In some embodiments, the biocide is formaldehyde. In other embodiments, the biocide is isothiazolinone or a derivative thereof.

The formulations of the invention optionally comprise a microbial inoculant such as Rhizobium.

The formulations of the invention can be applied to plants and parts thereof by any conventional means. In preferred embodiments, the formulations of the invention are applied to seed prior to planting.

The present application also provides methods for co-application of pesticides and inoculants to a plant or parts thereof using safeners of the invention.

Further provided are methods for reducing the toxicity of pesticide formulations on microbial inoculants using safeners of the invention.

### DETAILED DESCRIPTION

Before the subject disclosure is further described, it is to be understood that the disclosure is not limited to the particular embodiments of the disclosure described below, as variations of the particular embodiments may be made and still fall within the scope of the appended claims. It is also to be understood that the terminology employed is for the purpose of describing particular embodiments, and is not intended to be limiting. Instead, the scope of the present disclosure will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this disclosure belongs.

As used herein, a “pesticide” is a substance that increases mortality and/or reduces that growth rate of plant pests. The term is used herein to describe substances that exhibit activity against insects, mites, nematodes, fungi, undesired plants, weeds, and/or phytopathogens.

As used herein, the term “pest” or “pests” includes insects, mites, nematodes, fungi, and/or phytopathogens.

As used herein, the term “biocide” is a substance that are toxic to microorganisms.

As used herein, the term “safener” is a substance that reduces or eliminates the toxicity of a biocide.

As used herein, the term “microbial inoculant” is inclusive of all members of the stated inoculants' taxonomic classification. Microbial inoculants typically exert beneficial effects on plants. However, in some embodiments, microbial inoculants can include other microorganisms that do not provide agronomic benefit.

As used herein, “seed treatment” refers generally to contacting a seed with a compound or composition of matter containing or comprising at least one active ingredient (a.i. or Al). The compound or composition of matter may be in any form suitable to the seed, for example, liquid, spray or powder. Seed treatment is inclusive of seed coating and seed dressing.

As used herein, “seed coating” or “seed dressing” refers generally to a coating or matrix formed on at least part of the seed, the coating or matrix containing or comprising the at least one Al. Optional compounds or agents may be included in the seed coating to facilitate the seed coating process or the disintegration/releasing of the at least one Al from the coating, or to prevent excessive dust-off or to add color to the treated seed.

As used herein, the term “seed” is not limited to any particular type of seed and can refer to seed from a single plant species, a mixture of seed from multiple plant species, or a seed blend from various strains within a plant species. The disclosed and described compositions can be utilized to treat gymnosperm seed, dicotyledonous angiosperm seed and monocotyledonous angiosperm seed.

As used herein, the term “at least one” indicates that in any case, a substance as specified, such as a pesticide or derivative thereof, is present in the formulation according to the invention. However, more than one, such as (at least) two, (at least) three, (at least) four, (at least) five, or more of such substances may be present in the formulation according to the invention.

Some pesticide formulations contain biocides, such as formaldehyde, to improve shelf life by reducing bacterial contamination of the formulation. However, these biocides are also lethal to microbial inoculants, thus limiting the ability to co-apply biocide-containing pesticides and microbial inoculants, such as Rhizobia.

The subject disclosure features, in one aspect, safeners that reduce toxicity of biocides found within certain pesticides while maintaining efficacy of the pesticide.

Neutralization of formaldehyde by exposure of formaldehyde to sulfite ion, usually by adding sodium sulfite, sodium bisulfite, or a combination thereof, has been shown to be useful for disposal of formaldehyde waste. The reactions of formaldehyde with sodium sulphite and sodium bisulfite, respectively, are the following equilibrium reactions:

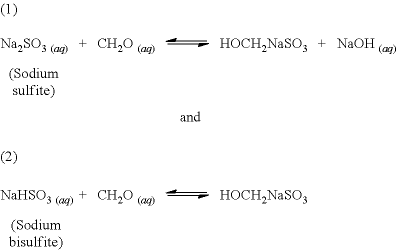

whereby sodium sulfite and sodium bisulfite each react with formaldehyde to yield sodium formaldehyde bisulfite (HOCH2NaSO3), a very stable compound in aqueous solution. The equilibrium for this reaction is shifted strongly to the right (towards the formation of sodium bisulfite formaldehyde) and the relative concentrations of sulfite ion and the free formaldehyde in the solution are very low after the reaction that forms sodium bisulfite formaldehyde.

However, sodium bisulfite is considered toxic to germinating and growing cells. Thus, use of sodium bisulfite to reduce the toxicity of formaldehyde-containing pesticide formulations on microbial inoculants, such as Rhizobium, was believed to be undesirable because of the potential toxicity to the inoculants. Indeed, glycine was considered preferable to neutralize formaldehyde in biological settings (See A. D. Russell, Clin Microbiol Rev 3(2):99-119, April 1990). Additionally, the reaction between formaldehyde and sodium bisulfite is reversible. Thus, it was widely believed that even if the sodium bisulfite did not kill the inoculant, enough formaldehyde might be available to kill the inoculant.

Another challenge in selecting an effective safener for formaldehyde is finding a safener that selectively deactivates formaldehyde without degrading the other active compounds within the formulation (e.g., insecticides). Sulfide containing nucleophiles can attack any sulfur-containing compound and lead to degradation. In particular, disulfide bonds are especially susceptible to scission by nucleophiles. For example, insecticidal formulations containing thiodicarb carry a thiocarbamoyl group, which is subject to nucleophilic attack, including sulfide or bisulfite attack. In addition, the S- of bisulfite can attack the sulfur atom of S—N within the thiodicarb chemical structure as typical in sulfur chemistry.

Another challenge is that insecticidal formulations are typically complex. Biocides, when present, usually are a small percentage of the formulation as a whole. Therefore, in order for the sodium bisulfite to work, and with minimal side reaction, it would need to be preferentially or selectively reactive with the biocide, such as formaldehyde and would need to be added in the right stoichiometric amount. For example, the degradant of thiodicarb can cause unwanted phytotoxicity on treated seeds.

Surprisingly, the subject disclosure describes safeners enabling the co-application of biocide-containing pesticides and microbial inoculants wherein the safener comprises sodium bisulfite. Without wishing to be bound to one particular theory, it is believed that, when combined with biocide (such as formaldehyde)-containing pesticides, sodium bisulfite reacts with the biocide as a nucleophile, reducing the toxicity of the biocide on microbial inoculants without reducing the efficacy of the active ingredients of the pesticidal formulation.

Thus, in one embodiment, the safeners of the invention comprise a sulfite. Sulfites which may be used in the safener includes, but are not limited to, sodium bisulfite, potassium bisulfite, lithium bisulfite, calcium bisulfite [i.e., sulfurous acid, calcium salt (1:1)]; Sulfurous acid, magnesium salt (1:1); Sulfurous acid, dicopper (1+) salt; Sulfurous acid, ammonium salt; Sulfurous acid, zinc salt (2:1); Sulfurous acid, calcium salt (2:1); Sulfurous acid, magnesium salt (2:1); Sulfurous acid, sodium salt (1:2); Sulfurous acid, zinc salt (1:1); Sulfurous acid, manganese (2+) salt (1:1); 1-Butanaminium, N,N,N-tributyl-, sulfite (1:1); Ethanamine, N,N-diethyl-, sulfite (1:1); Sulfurous acid, aluminum salt (3:1); Sulfurous acid, aluminum salt (3:2); Methanamine, N,N-dimethyl-, sulfite (1:1); Sulfurous acid, sodium salt (1:2) (i.e., sodium sulfite); sodium metabisulfite; and/or any combination or mixture thereof.

In a preferred embodiment, the safener of the invention comprises sodium bisulfite or derivatives thereof, such as, for example, sodium metabisulfite and urecilsulphonate.

In a preferred embodiment, the safener comprises both a sulfite and an amine. In a preferred embodiment, the sulfite is sodium bisulfite. Alternatively, the safener comprises an amine without a sulfite. In some embodiments, the amine is a N-monoalkyl amine or a N,N-dialkyl amine. The alkyl group can also be a 3 to 7 carbon chain, including branched or cyclic chains, including, for example, benzyl and/or phenyl. In a preferred embodiment, the alkyl chain is from one carbon to six carbons in length. The alkyl group can be the same or different. Examples of amines that may be used according to the invention include, but are not limited to, N-methylamine; N-ethylamine; N-benzylamine; N-propylamine; N-butylamine; N-allylamine; N,N-diallylamine; N,N-diethylamine; N-N-dimethylamine; N-methyl,N-ethylamine; cyclopropylamine; aziridine; pyrrolidine; piperidine; morpholine and/or any combination or mixture thereof. In some embodiments, the amine is N,N-diethylamine. In a preferred embodiment, the amine is N,N-dimethylamine.

In some embodiments, the amine(s) may be added to a pesticide formulation concurrently with the sulfite(s). In other embodiments, the amine(s) may be added to a pesticide formulation after addition of the sulfite(s) to the pesticide formulation.

The mole ratio of the sulfite to the amine may be any ratio between 5:1 and 1:5. In some embodiments, the sulfite is provided in a mole ratio of about 5:1 to about 1:5 to the amine. In other embodiments, the sulfite is provided in a mole ratio of about 4:1 to about 1:4 to the amine. In other embodiments, the sulfite is provided in a mole ratio of about 3:1 to about 1:3 to the amine. In other embodiments, the sulfite is provided in a mole ratio of about 2:1 to about 1:2 to the amine. In other embodiments, the sulfite is provided in a mole ratio of about 1.5:1 to about 1:1.5 to the amine.

In some embodiments, the mole ratio of the sulfite to the amine is about 5:1, about 4:1, about 3:1, about 2:1, about 1.5:1, about 1.25:1, about 1.1:1, about 1:1, about 1:1.1, about 1:1.25, about 1:1.5, about 1:2, about 1:3, about 1:4, or about 1:5.

In a preferred embodiment, the sulfite and amine are present in a 1:1 mole ratio within the safener of the invention. In other embodiments, the sulfite and amine are present in a 1:0.95 or a 0.95:1 mole ratio within the formulation of the invention.

In another embodiment, the safener comprises a hydrazine. The hydrazine can be used alone or in combination with a sulfite or combination with an amine or in combination with both. Examples of hydrazines that may be used according to the invention include, but are not limited to, phenylhydrazine; 2,4-dinitrophenylhydrazine; (4-methylphenyl)hydrazine hydrochloride (1:1); (3-methylphenyl)hydrazine hydrochloride (1:1); (2-methylphenyl)hydrazine hydrochloride (1:1); (4-chlorophenyl)hydrazine hydrochloride (1:1); (2-chlorophenyl)hydrazine hydrochloride (1:1), (2-chlorophenyl)hydrazine hydrochloride (1:1); hydrazine carboxamide; carbonic dihydrazide; N-methylhydrazine carboxamide; 2-(aminocarbonyl)carbonic dihydrazide; N-nitrohydrazine carboxamide; N-methoxyhydrazine carboxamide; phenoxyamine; hydroxylamine, methoxyamine, ethoxyamine, and/or substituents, derivatives, or combinations thereof.

In additional embodiments, the safener may further comprise an oxidant such as ammonium hydroxide, hydrogen peroxide, potassium permanganate, manganese dioxide, and/or peracetic acid, and/or combinations thereof.

The safener may further comprise a biological such as yeast extract, milk powder, sodium glutamic acid, and/or glutathione, and/or combinations thereof.

Also provided by the subject disclosure is a formulation comprising at least one pesticide, at least one biocide, and at least one safener which reduces toxicity of the biocide while maintaining efficacy of the pesticide. The pesticide(s), biocide(s), and safener(s) are each present in an amount sufficient to produce the desired effect. For example, the pesticide is present in an amount sufficient to provide the desired pesticidal effect. The biocide is present in an amount sufficient present in an amount sufficient to provide the desired biocidal effect, preferably in an amount sufficient to reduce or prevent contamination of the formulation. The safener is present in an amount sufficient to provide the desired safening effect, preferably in an amount sufficient to neutralize the biocide. Those skilled in the art will understand that the amount of each component may vary depending on the size and/or type of plant or seed to be treated.

In some embodiments, the pesticide is present in an amount from about 1% to about 90% w/w based on the entire formulation. In a preferred embodiment, the pesticide is present in an amount from about 10% to about 60% w/w based on the entire formulation. In a more preferred embodiment, the pesticide is present in an amount from about 20% to about 50% w/w based on the entire formulation. In some embodiments, the pesticide is present in an amount from 1° A to 90% w/w, more preferably, in an amount from 10% to 60% w/w, most preferably, in an amount from 20% to 50% w/w.

In some embodiments, the biocide is present in an amount from about 0.01% to about 5% w/w based on the entire formulation. In a preferred embodiment, the biocide is present in an amount from about 0.1% to about 2.5% based on the entire formulation. In some embodiments, the biocide is present in an amount from 0.01% to 5% w/w, more preferably, in an amount from 0.1% to 2.5% w/w.

In some embodiments, the safener is present in an amount from about 0.01% to about 5% w/w based on the entire formulation. In a preferred embodiment, the safener is present in an amount from about 0.1% to about 2.5% based on the entire formulation. In some embodiments, the safener is present in an amount from 0.01% to 5% w/w, more preferably, in an amount from 0.1% to 2.5% w/w.

Preferred safeners for use in the formulations of the invention are those described above.

The formulation of the invention includes any pesticide. The active compounds identified here by their common name are known and are described, for example, in the pesticide handbook (“The Pesticide Manual” 14th Ed., British Crop Protection Council 2006) or can be found on the Internet (e.g. alanwood.net/pesticides).

In some embodiments, the at least one pesticide is any pesticide comprising at least one thio-N carbamoyl functional group.

The at least one pesticide of the invention can be, but is not limited to, a carbamate such as alanycarb, aldicarb, aldoxycarb, allyxycarb, aminocarb, bendiocarb, benfuracarb, butacarb, butocarboxim, butoxy-carboxim, carbaryl, carbofuran, carbosulfan, chlorethocarb, Cyazypyr® (cyantraniliprole), dimetilan, ethiofencarb, ethiprole, fenobucarb, fenothiocarb, fenoxycarb, fipronil, flupyram, flupyradifurone, formetanate, furathiocarb, isoprocarb, metam-sodium, methiocarb, methomyl, metolcarb, oxamyl, phosphocarb, pirimicarb, promecarb, propoxur, Rynaxypyr® (chlorantraniliprole), tetraniliprole, thiodicarb, thiofanox, triazamate, trimethacarb, XMC, xylylcarb, and/or derivatives and/or combinations thereof.

In some embodiments, the at least one pesticide of the invention can be, but is not limited to, clothianidin, imidacloprid, thiacloprid, thiamethoxam, acetamiprid, dinotefuran, nitenpyram, and/or combinations thereof.

In a preferred embodiment, the pesticide is selected from thiodicarb, imidacloprid, and/or combinations thereof.

The at least one biocide of the invention can be, but is not limited to, 5-chloro-2-methyl-3(2H)-isothiazolone (e.g., trade name, Kathan), o-phenylphenol, sodium o-phenylphenate, cis-1-(chloroallyl)-3,5,7-triaza-1-azoniaadamantane chloride, 7-ethyl bicyclooxazolidine, 2,2-dibromo-3-nitrilopropionamide, bronopol (2-bromo-2-nitropropane-1,3-diol), glutaraldehyde, copper hydroxide, cresol, diazolidinyl urea, dichlorophen, dipyrithione, DMDM hydantoin, dodidin, fenaminosulf, formaldehyde, hydrargaphen, hydroxymethylglycinate, 8-hydroxyquinoline sulfate, imidazolidinyl urea, kasugamycin, nitrapyrin, octhilinone, oxolinic acid, oxytetracycline, probenazole, streptomycin, tecloftalam, thimerosal, polyquaternary ammonium chloride, quaternium-15, alkylbenzyl dimethyl ammonium chloride, 2-methyl-4-isothiazolone, 2-ethyl-4-isothiazolin-3-one, 2-propyl-4-isothiazolin-3-one, 2-butyl-4-isothiazolin-3-one, 2-amyl-4-isothiazolin-3-one, 5-chloro-2-methyl-4-isothiazolin-3-one, 5-bromo-2-methyl-4-isothiazolin-3-one, 5-iodo-2-methyl-4-isothiazolin-3-one, 5-chloro-2-butyl-4-isothiazolin-3-one, 5-bromo-5-nitro-1,3-dioxane, 5-bromo-2-ethyl-4-isothiazolin-3-one, 5-iodo-2-amyl-4-isothiazolin-3-one, 2-noctyl-4-isothiazolin-3-one, 4,5-dichloro-2-n-octyl-4-isothiazolin-3-one, and/or 1,2-benzisothiazolin-3-one.

In a preferred embodiment, the biocide is formaldehyde and/or derivatives and/or precursors thereof. For example, the biocide may be, but is not limited to, one of the following: a formaldehyde-releasing compound such as Preventol D2® (Laxness), quaternium-15, imidazolidinyl urea, diazolidinyl urea, dimethyl-dimethyl (DMDM) hydantoin, sodium hydroxymethylglycinate, 2-bromo-2-nitropropane-1,3-diol (bromopol), glutaraldehyde and/or polymers and/or formulations thereof such as glutaraldehyde-phenol-sodium phenate, potentiated acid glutaraldehyde, and stabilized alkaline glutaraldehyde, paraformaldehyde, and/or other aldehydes including, but not limited to, acetaldehyde, propyl aldehyde, butyl aldehyde, benzyl aldehyde, and/or longer chain alkyl aldehydes including branched chain alkyl or phenylallkyl aldehydes, and/or combinations thereof.

In other embodiments, the biocide is isothiazolinone or a derivative of isothiazolinone such as, but not limited to, methylisothiazolinone (MIT, MI), chloromethylisothiazolinone (CMIT, CMI, MCI), benzisothiazolinone (BIT), octylisothiazolinone (OIT, OI), dichlorooctylisothiazolinone (DCOIT, DCOI), and/or butylbenzithiazolinone (BBIT).

The safener of the invention is present in an amount sufficient to provide the desired safening effect. For example, the mole ratio of the safener to the biocide may be any ratio between 5:1 and 1:5. In some embodiments, the safener of the invention is provided in a mole ratio of about 5:1 to about 1:5 to the biocide. In other embodiments, the safener of the invention is provided in a mole ratio of about 4:1 to about 1:4 to the biocide. In other embodiments, the safener of the invention is provided in a mole ratio of about 3:1 to about 1:3 to the biocide. In other embodiments, the safener of the invention is provided in a mole ratio of about 2:1 to about 1:2 to the biocide. In other embodiments, the safener of the invention is provided in a mole ratio of about 1.5:1 to about 1:1.5 to the biocide.

In some embodiments, the mole ratio of the safener to the biocide is about 5:1, about 4:1, about 3:1, about 2:1, about 1.5:1, about 1.25:1, about 1.1:1, about 1:1, about 1:1.1, about 1:1.25, about 1:1.5, about 1:2, about 1:3, about 1:4, or about 1:5.

In a preferred embodiment, the safener and biocide is present in a 1:1 mole ratio within the formulation of the invention. In other embodiments, the safener and biocide is present in a 1:0.95 or a 0.95:1 mole ratio within the formulation of the invention.

In some embodiments, the formulations of the invention further comprise a microbial inoculant. The inoculant is present in an amount sufficient to provide the desired effect. The amount of the inoculant can vary depending on the final formulation as well as the size or type of plant or seed to be treated. Preferably, the inoculant is present in an amount from about 2% to about 80% w/w of the entire formulation. More preferably, the inoculant is present in an amount from about 5% to about 65% w/w and most preferably, in an amount from about 10% to about 60% w/w of the entire formulation.

For example, formulations of the invention may further comprise at least one of the following inoculants: Rhizobium, Bradyrhizobium, Bacillus, Azobacter, Arthrobacter, Pseudomonas, Azospirillium, cyanobacteria, and mycorrihizal fungae.

Inoculants can include bacterial strains Herbaspirillum seropedicae 2A, Pantoea agglomerans P101, Pantoea agglomerans P102, Klebsiella pneumoniae 342, Klebsiella pneumoniae zmvsy, Herbaspirillum seropedicae Z152, Gluconacetobacter diazotrophicus PA15, with or without a carrier. The inoculant can also include strains of the bacterium Pantoea agglomerans and K. pneumoniae, which are able to enhance the growth of cereal grasses. Bacterial strains of Herbaspirillum seropedicae 2A, Pantoea agglomerans P101 and P102, and Klebsiella pneumoniae 342 and zmvsy can also be used.

Inoculants of the invention include nitrogen-fixing bacteria inoculants such as rhizobacteria, for example, Rhizobium japonicum and Bradyrhizobium japonicum and closely related genera. Genetically modified Rhizobium, such as trifolitoxin expressing types, are examples of trans-inoculants. Nitrogen-fixing bacteria is useful for non-leguminous crops, for example, Azospirillum, and diazotrophic rhizobacteria for cereal crops.

Bradyrhizobium species useful as inoculants according to the invention specifically include the commercially important soybean nodulating strains B. japonicum (i.e., strains USDA 110 and 123), promiscuous rhizobia of the cowpea group, and B. parasponia (formerly Parasponia rhizobium) which nodulates the non-legume Parasponia, as well as a number of tropical legumes, including cowpea and siratro. An important agricultural host of B. japonicum is soybean (Glycine max), but this bacterium will nodulate a few other legumes (e.g., cowpea and siratro). Fast growing rhizobia include, among others, Rhizobium etli, Sinorhizobium meliloti (formerly Rhizobium meliloti), and Rhizobium leguminosarum biovar trifolii, which nodulate bean, alfalfa, and clover, respectively. Rhizobium sp. NGR234, for example, has been shown to nodulate over 100 genera of legumes. Sinorhizobium fredii (formerly Rhizobium fredii), is phylogenetically distinct from B. japonicum, but has the ability to nodulate Glycine soja (a wild soybean species), G. max cv. Peking, and a few other soybean cultivars. High-yielding NoIA insensitive B. japonicum and noIA inducers can be employed for situations involving inefficient nodulation due to indigenous B. japonicum strains.

In some embodiments, the inoculants of the invention include certain soil bacteria, such as Gram-negative strains including Pantoea agglomerans and related diazotrophs. These soil bacteria are useful for stimulating nodulation in legumes and perhaps limit growth of phytopathogenic fungi. Other bacterial strains include Burkholderia cepacia 2J6 (ATCC Accession No. 55982), Burkholderia cepacia AMMD 2358 (ATCC Accession No. 55983) and Azospirillum brasilense SAB MKB having accession number NRRL B-30081. Other examples of soil bacteria include, for example, Bacillus subtilis, known as the hay bacillus or grass bacillus, a Gram-positive, catalase-positive bacterium, Bacillus pumilus (e.g., strain GB34) useful for protecting the roots of the soybean plant against certain fungi.

Examples of phosphate-solubilizing bacteria include, for example, Agrobacterium radiobacter.

Examples of fungal inoculants include, for example, vesicular-arbuscular mycorrhizae (VAM), arbuscular mycorrhizae (AM), Penicillium bilaii, and endophytic fungi, such as Piriformis indica. Other fungal inoculants can include, for example, members of the Trichoderma genus of fungi characterized as opportunistic avirulent plant symbionts effective against fungal diseases of root surfaces, e.g., the species T. harzianum, T. viride and T. hamatum.

Specific combinations envisaged include, for example, Penicillium bilaii and Rhizobium spp (inclusive of Rhizobium genus and Bradyrhizobium genus).

Examples of composite inoculants include, for example, the combination of strains of plant growth promoting Rhizobacteria (PGPR) and arbuscular mycorrhizae, or multiple strain inoculants where only one strain is diazotrophic.

The formulations of the invention may optionally comprise one or more of the following: adjuvants, surfactants, solvents, polymers, anti-foaming agents, pigments, additives, stabilizers, dispersants, and/or wetting agents.

Surfactants according to the invention may be anionic or non-ionic. Examples of anionic surfactant include, but are not limited to, carboxylates, sulfates, sulfonates, phosphates in combination with linear hydrocarbon or aromatic hydrophobic groups. Examples of non-ionic surfactants include, but are not limited to, alcohol ethoxylates, alkyly phenol ethoxylates, fatty acid ethoxylates, sorbitan esters and/or ethoxylated derivatives thereof, ethoxylated fats and oils, amine ethoxylates, ethylene oxide-propylene oxide copolymers, mono and polysaccharide derivatives.

The formulations of the invention are preferably pH neutral. In some embodiments, the pH of the formulations is between 6.0 and 8.0. In a preferred embodiment, the pH of the formulations is between 6.5 and 7.5. In other embodiments, the pH of the formulation may be 4.0 or higher.

The subject disclosure also relates to methods for co-application of pesticides and inoculants to a plant or parts thereof using the safeners of the invention.

Further provided are methods for reducing the toxicity of pesticide formulations on microbial inoculants using the safeners of the invention.

Also provided are methods for treating a plant comprising: providing at least one pesticide formulation, at least one biocide, a safener, and at least one microbial inoculant; and applying the at least one pesticide formulation, at least one biocide, safener, and at least one microbial inoculant to the plant. In certain embodiments, the at least one pesticide formulation, at least one biocide, safener, and at least one microbial inoculant is applied to soil, a seed, fruit, and/or a plant or a portion thereof.

In some embodiments, one or more of the at least one pesticide formulation, at least one biocide, safener, and at least one microbial inoculant are mixed prior to applying to the plant. For example, one or more of the at least one pesticide formulation, at least one biocide, safener, and at least one microbial inoculant are provided in a single formulation.

In some embodiments, one or more of the at least one pesticide formulation, at least one biocide, safener, and at least one microbial inoculant are applied to the plant separately. In certain embodiments, the safener is applied to the plant concurrently with the biocide. In other embodiments, the safener is applied to the plant after application of the biocide. In a preferred embodiment, the safener and the biocide are applied to the plant in a mole ratio of 1:1.

Formulations of the invention can be applied to plants or parts thereof in any desired manner, such as in the form of a seed coating, soil drench, and/or directly in-furrow and/or as a foliar spray and applied either pre-emergence, post-emergence or both. In other word, the formulations of the invention can be applied to the seed, the plant, or to the fruit of the plant, or to the soil wherein the plant is growing or wherein it is desired to grow.

Formulations of the invention can be applied to a single seed or to an assemblage of seeds in bulk or in a continuous process. In some embodiments, the composition is applied to an agricultural or horticultural seed, more especially a food crop. A “food crop” herein means a crop grown primarily for human consumption. Methods disclosed herein are appropriate both for immediately prior to sowing or for stored seed.

The present invention provides methods of treating a plant by application of any of a variety of customary formulations in an effective amount to either the soil (i.e., in-furrow), a portion of the plant (i.e., drench) or on the seed before planting (i.e., seed coating or dressing). Customary formulations include solutions (SL), emulsifiable concentrate (EC), wettable powders (WP), suspension concentrate (SC and FS), wettable powder (WP), soluble powders (SP), granules (GR), suspension-emulsion concentrate (SE), natural and synthetic materials impregnated with active compound, and very fine control release (CR) capsules in polymeric substances.

In one embodiment, the pesticide formulation, the safener, and the microbial inoculant are formulated in powders that either are available in a ready-to-use formulation or are mixed together at the time of use. In either embodiment, the powder may be admixed with the soil prior to or at the time of planting. In an alternative embodiment, any one or more of the pesticide formulation, the safener, and/or the microbial inoculant is a liquid formulation that is mixed together at the time of treating. One of ordinary skill in the art understands that an effective amount of the inventive compositions depends on the final formulation of the composition as well as the size of the plant or the size of the seed to be treated.

In embodiments wherein the safener comprises both sodium bisulfite and N,N-dimethylamine, N,N-dimethylamine may be mixed with sodium bisulfite. In other embodiments, N,N-dimethylamine is added to a pesticide formulation after addition of sodium bisulfite to the pesticide formulation.

Depending on the final formulation and method of application, one or more suitable additives can also be introduced to the present compositions. Adhesives such as carboxymethylcellulose and natural and synthetic polymers in the form of powders, granules or latexes, such as gum arabic, chitin, polyvinyl alcohol and polyvinyl acetate, as well as natural phospholipids, such as cephalins and lecithins, and synthetic phospholipids, can be added to the present compositions.

In a preferred embodiment, the compositions are formulated in a single, stable solution, or emulsion, or suspension. For solutions, the active chemical compounds (i.e., the insect control agent) are dissolved in solvents before the biological control agent is added. Suitable liquid solvents include petroleum based aromatics, such as xylene, toluene or alkylnaphthalenes, aliphatic hydrocarbons, such as cyclohexane or paraffins, for example petroleum fractions, mineral and vegetable oils, alcohols, such as butanol or glycol as well as their ethers and esters, ketones, such as methyl ethyl ketone, methyl isobutyl ketone or cyclohexanone, strongly polar solvents, such as dimethylformamide and dimethyl sulphoxide. For emulsion or suspension, the liquid medium is water. In one embodiment, the pesticide formulation, the safener, and the microbial inoculant are suspended in separate liquids and mixed at the time of application. In a preferred embodiment of suspension, the pesticide formulation, the safener, and the microbial inoculant are combined in a ready-to-use formulation that exhibits a shelf life of at least two years. In use, the liquid can be sprayed or atomized foliarly or in-furrow at the time of planting the crop. The liquid composition can be introduced to the soil before germination of the seed or directly to the soil in contact with the roots by utilizing a variety of techniques including, but not limited to, drip irrigation, sprinklers, soil injection or soil drenching.

Optionally, stabilizers and buffers can be added, including alkaline and alkaline earth metal salts and organic acids, such as citric acid and ascorbic acid, inorganic acids, such as hydrochloric acid or sulfuric acid.

In one embodiment, the solid or liquid compositions further contain functional agents capable of protecting seeds from the harmful effects of selective herbicides such as activated carbon, nutrients (fertilizers), and other agents capable of improving the germination and quality of the products or a combination thereof.

In a particularly preferred embodiment, the compositions of the present invention are formulated as a seed treatment. The seed treatment comprises at least one insect control agent and at least one biological control agent. According to the present invention, the seeds are substantially uniformly coated with one or more layers of the compositions disclosed herein using conventional methods of mixing, spraying or a combination thereof through the use of treatment application equipment that is specifically designed and manufactured to accurately, safely, and efficiently apply seed treatment products to seeds. Such equipment uses various types of coating technology such as rotary coaters, drum coaters, fluidized bed techniques, spouted beds, rotary mists or a combination thereof. Liquid seed treatments such as those of the present invention can be applied via either a spinning “atomizer” disk or a spray nozzle, which evenly distributes the seed treatment onto the seed as it moves though the spray pattern. Preferably, the seed is then mixed or tumbled for an additional period of time to achieve additional treatment distribution and drying. The seeds can be primed or unprimed before coating with the inventive compositions to increase the uniformity of germination and emergence. In an alternative embodiment, a dry powder formulation can be metered onto the moving seed and allowed to mix until completely distributed.

The seeds may be coated via a batch or continuous coating process. In a continuous coating embodiment, continuous flow equipment simultaneously meters both the seed flow and the seed treatment products. A slide gate, cone and orifice, seed wheel, or weighing device (belt or diverter) regulates seed flow. Once the seed flow rate through treating equipment is determined, the flow rate of the seed treatment is calibrated to the seed flow rate in order to deliver the desired dose to the seed as it flows through the seed treating equipment. Additionally, a computer system may monitor the seed input to the coating machine, thereby maintaining a constant flow of the appropriate amount of seed.

In a batch coating embodiment, batch treating equipment weighs out a prescribed amount of seed and places the seed into a closed treating chamber or bowl where the corresponding dose of seed treatment is then applied. This batch is then dumped out of the treating chamber in preparation for the treatment of the next batch. With computer control systems, this batch process is automated enabling it to continuously repeat the batch treating process.

In either embodiment, the seed coating machinery can optionally be operated by a programmable logic controller that allows various equipment to be started and stopped without employee intervention. The components of this system are commercially available through several sources such as Gustafson Equipment of Shakopee, Minn.

A variety of additives can be added to the seed treatment formulations comprising the inventive compositions. Binders can be added and include those composed preferably of an adhesive polymer that can be natural or synthetic without phytotoxic effect on the seed to be coated. Any of a variety of colorants may be employed, including organic chromophores classified as nitroso, nitro, azo, including monoazo, bisazo and polyazo, diphenylmethane, triarylmethane, xanthene, methine, acridine, thiazole, thiazine, indamine, indophenol, azine, oxazine, anthraquinone and phthalocyanine. Other additives that can be added include trace nutrients such as salts of iron, manganese, boron, copper, cobalt, molybdenum and zinc. A polymer or other dust control agent can be applied to retain the treatment on the seed surface.

Other conventional seed treatment additives include, but are not limited to, coating agents, wetting agents, buffering agents, and polysaccharides. At least one agriculturally acceptable carrier can be added to the seed treatment formulation such as water, solids or dry powders. The dry powders can be derived from a variety of materials such as calcium carbonate, gypsum, vermiculite, talc, humus, activated charcoal, and various phosphorous compounds.

In one embodiment, the seed coating composition can comprise at least one filler, which is an organic or inorganic, natural or synthetic component with which the active components are combined to facilitate its application onto the seed. Preferably, the filler is an inert solid such as clays, natural or synthetic silicates, silica, resins, waxes, solid fertilizers (for example ammonium salts), natural soil minerals, such as kaolins, clays, talc, lime, quartz, attapulgite, montmorillonite, bentonite or diatomaceous earths, or synthetic minerals, such as silica, alumina or silicates, in particular aluminum or magnesium silicates.

While the present formulations can be beneficial for gramineous (belonging to the grass family) crops such as cereal crops, including corn, wheat, barley, oats, rye, triticale, and rice, they are also highly appropriate for non-gramineous crops, including vegetable crops, fruit crops, seed crops, and woody plants. The terms “fruit” and “vegetable” herein are used in their agricultural or culinary sense, not in a strict botanical sense; for example, tomatoes, cucumbers and zucchini are considered vegetables for present purposes, although botanically speaking it is the fruit of these crops that is consumed. Vegetable crops for which the present methods can be found useful include without limitation:

leafy and salad vegetables such as amaranth, beet greens, bitterleaf, bok choy, Brussels sprout, cabbage, catsear, celtuce, choukwee, Ceylon spinach, chicory, Chinese mallow, chrysanthemum leaf, corn salad, cress, dandelion, endive, epazote, fat hen, fiddlehead, fluted pumpkin, golden samphire, Good King Henry, ice plant, jambu, kai-lan, kale, komatsuna, kuka, Lagos bologi, land cress, lettuce, lizard's tail, melokhia, mizuna greens, mustard, Chinese cabbage, New Zealand spinach, orache, pea leaf, polk, radicchio, rocket (arugula), samphire, sea beet, seakale, Sierra Leone bologi, soko, sorrel, spinach, summer purslane, Swiss chard, tatsoi, turnip greens, watercress, water spinach, winter purslane and you choy; podded vegetables (legumes) such as American groundnut, azuki bean, black bean, black-eyed pea, chickpea (garbanzo bean), drumstick, dolichos bean, fava bean (broad bean), French bean, guar, haricot bean, horse gram, Indian pea, kidney bean, lentil, lima bean, moth bean, mung bean, navy bean, okra, pea, peanut (groundnut), pigeon pea, pinto bean, rice bean, runner bean, soybean, tarwi, tepary bean, urad bean, velvet bean, winged bean and yardlong bean;

bulb and stem vegetables such as asparagus, cardoon, celeriac, celery, elephant garlic, fennel, garlic, kohlrabi, kurrat, leek, lotus root, nopal, onion, Prussian asparagus, shallot, Welsh onion and wild leek;

root and tuber vegetables, such as ahipa, arracacha, bamboo shoot, beetroot, black cumin, burdock, broadleaf arrowhead, camas, canna, carrot, cassava, Chinese artichoke, daikon, earthnut pea, elephant-foot yam, ensete, ginger, gobo, Hamburg parsley, horseradish, Jerusalem artichoke, jicama, parsnip, pignut, plectranthus, potato, prairie turnip, radish, rutabaga (swede), salsify, scorzonera, skirret, sweet potato, taro, ti, tigernut, turnip, ulluco, wasabi, water chestnut, yacon and yam; and

herbs, such as angelica, anise, basil, bergamot, caraway, cardamom, chamomile, chives, cilantro, coriander, dill, fennel, ginseng, jasmine, lavender, lemon balm, lemon basil, lemongrass, marjoram, mint, oregano, parsley, poppy, saffron, sage, star anise, tarragon, thyme, turmeric and vanilla.

Fruit crops for which the present methods can be found useful include without limitation apple, apricot, banana, blackberry, blackcurrant, blueberry, boysenberry, cantaloupe, cherry, citron, clementine, cranberry, damson, dragonfruit, fig, grape, grapefruit, greengage, gooseberry, guava, honeydew, jackfruit, key lime, kiwifruit, kumquat, lemon, lime, loganberry, longan, loquat, mandarin, mango, mangosteen, melon, muskmelon, orange, papaya, peach, pear, persimmon, pineapple, plantain, plum, pomelo, prickly pear, quince, raspberry, redcurrant, starfruit, strawberry, tangelo, tangerine, tayberry, ugli fruit and watermelon.

Seed crops, for example, specialized crops used to produce seed of any plant species, for which the present methods can be found useful include, in addition to cereals (e.g., barley, corn (maize), millet, oats, rice, rye, sorghum (milo) and wheat), non-gramineous seed crops such as buckwheat, cotton, flaxseed (linseed), mustard, poppy, rapeseed (including canola), safflower, sesame and sunflower.

Woody plants for which the present methods can be found useful include, but are not limited to, trees such as apple trees, shrubs such as almond shrubs, hazelnut shrubs, and blueberry shrubs, and vines (lianas) such as grapevines.

Each of the crops listed above has its own particular nutrition and disease protection needs. Further optimization of compositions described herein for particular crops can readily be undertaken by those of skill in the art, based on the present disclosure, without undue experimentation.

Exemplary plants suitable for use according to the invention include legumes. Examples of legumes suitable for use herein include, but are not limited to, grain legumes such as various varieties of beans, lentils, lupins, peas, and peanuts, soybean, and peas. Exemplary, non-limiting examples include American groundnut, azuki bean, black bean, black-eyed pea, chickpea (garbanzo bean), drumstick, dolichos bean, fava bean (broad bean), French bean, guar, haricot bean, horse gram, Indian pea, kidney bean, lentil, lima bean, moth bean, mung bean, navy bean, okra, pea, peanut (groundnut), pigeon pea, pinto bean, rice bean, runner bean, soybean, tarwi, tepary bean, urad bean, velvet bean, winged bean and yardlong bean, and industrial legumes of the Indigofera and Acacia species. Other exemplary legumes suitable for the formulations and compositions disclosed herein include, for example, Pink Beans, Green Baby Lima, Chickpea Café Type, Dark Red Kidney Beans, Black Beans, Small red Beans, Cranberry Beans Great Northern bean Small Red, Milky White, Pedrosillano, Athena, Beluga, Crimson, Crimson Decorticated, Eston, French Green, Pardina, Red Chief, Red Chief Decorticated, Richle, a Large Green, Regular, Austrian Winter, Whole Green, Green Split, Marrowfat, Whole Yellow, and Yellow Split. Forage legumes, such as alfalfa, Alsike Clover, Arrowleaf Clover, Berseem Clover, Birdsfoot Trefoil, Cicer Milkvetch, Crimson Clover, Hairy Vetch, Kura Clover, Ladino Clover, Mammoth Red Clover, Medium Red Clover, Sainfoin, Strawberry Clover, White Clover, and Yellow Blossom Sweet Clover. Fallow/green manure legume species, such as, Leucaena, Cyamopsis, and Sesbania species. Other legume species include the numerous Acacia species and Castanospermum australe.

The following Examples describe exemplary embodiments of the invention. These Examples should not be interpreted to encompass the entire breadth of the invention.

### EXAMPLES

### Example 1

Use of sodium bisulfite to neutralize formaldehyde in an insecticidal formulation.

Sodium bisulfite was added to CropStar® (150 g/L imidacloprid+450 g/L thiodicarb; Bayer CropScience) in various mole ratios to formaldehyde (0.5:1, 1:1, 2:1, and 5:1) with or without pH adjustment to pH 7. Efficacy of sodium bisulfite was compared to no safener (Sample Nos. 1 & 5), two comparative safeners (Safener 1 & Safener 2), and inoculum only (BIAGRO Liquido NG—liquid inoculant and BIAGRO 10 Plus—peat-based inoculant). Safener 1 was obtained from Novozymes and contains the following active ingredients: soybean oil (CAS #8001-22-7), hydrolysed starch syrups (CAS #8029-43-4), and yeast extract (CAS #8013-01-2). Safener 2 was provided by Biagro and contains the following active ingredients: yeast extract, K₂HPO₄, and milk powder.

The results shown below in Table 1 demonstrate that a 1:1 mole ratio of sodium bisulfite to formaldehyde did not significantly affect biocide activity. A 1:1 mole ratio of sodium bisulfite to formaldehyde also did not significantly degrade thiodicarb.

Sodium bisulfite was shown to be a selective neutralizing agent for formaldehyde in the presence of thiodicarb and imidacloprid. Sodium bisulfite was shown to be a selective neutralizing agent for formaldehyde in pesticides containing a thio-N carbamoyl functional group.

As demonstrated by the data in Table 1, sodium bisulfite was found to be an efficient formaldehyde neutralizer in a complex formulation of CropStar® without affecting the physical stability of the formulation.

TABLE 1

| | | | | | Sample |
|---|---|---|---|---|---|
| Sample | | | Average | | Mass |
| No. | Sample Description | pH | cfu/g | RSD | (g) |
| 1 | CropStar ® original pH | 4.76 | 6.03E+08 | 37.94% | 2.02 |
| 2 | CropStar ® original pH plus Safener 1 | 6.05 | 9.20E+08 | 25.03% | 2.13 |
| | 8 mL for 50 g | | | | |
| 3 | CropStar ® original pH plus Safener 2 | 6.58 | 4.81E+08 | 14.14% | 2.10 |
| 4 | CropStar ® without pH adjustment + 1 mol | 4.75 | 9.76E+08 | 7.95% | 2.13 |
| | eq sodium bisulfite (60.5 mg)* | | | | |
| 5 | CropStar ® adjusted to pH 7 with K2HPO4 | 7.20 | 5.02E+08 | 13.76% | 2.03 |
| 6 | CropStar ® adjusted to pH 7 with K2HPO4 + | 7.15 | 7.36E+08 | 12.14% | 2.03 |
| | 0.5 mol eq sodium bisulfite (30.25 mg)* | | | | |
| 7 | CropStar ® adjusted to pH 7 with K2HPO4 + | 7.10 | 1.25E+09 | 14.46% | 2.02 |
| | 1 mol eq sodium bisulfite (60.5 mg)* | | | | |
| 8 | CropStar ® adjusted to pH 7 with K2HPO4 + | 7.10 | 1.25E+09 | 9.43% | 2.05 |
| | 2 mol eq sodium bisulfite (121 mg)* | | | | |
| 9 | CropStar ® adjusted to pH 7 with K2HPO4 + | 7.13 | 1.34E+09 | 13.50% | 2.01 |
| | 5 mol eq sodium bisulfite (302.5 mg)* | | | | |
| 10 | Inoculum only | 7.20 | 1.26E+09 | 7.86% | 2.12 |

*Sodium Bisulfite mol equivalent calculation based on Preventol D2 ® molecular concentration in CropStar ®

The results for sodium bisulfite were superior to other proposed methods as shown in Table 1. Considering that CropStar® is a complex formulation composed of more than 12 different chemical components, selectivity of one nucleophile (i.e., sodium bisulfite) onto one electrophile (i.e., formaldehyde) is remarkable and surprising.

### Example 2

Stability of adduct formed by formaldehyde and sodium bisulfite in the presence of N,N-dimethylamine.

In a small vial, 137 mg of formaldehyde sodium bisulfite (CAS 870-72-4) was combined with 10 mL of high purity water and 200 mg of N,N-dimethylamine and stirred at room temperature to mix. The resulting mixture was stored at room temperature.

Aliquots of the mixture was analysed by C-13 NMR spectral analysis 48 hours and 18 days following formation.

C-13 NMR spectral comparison at 48 hours and 18 days indicates that approximately 3.5% of the N,N-dimethyl adduct (CAS 68507-34-6) was converted back to the formaldehyde bisulfite adduct (CAS 870-34-6) after 18 days at room temperature in aqueous solution.

This result suggests additional stability for 1-(dimethylamino)-methanesulfonic acid in aqueous solution compared with formaldehyde sodium bisulfite adduct (CAS 870-72-4). In other words, in aqueous solution at room temperature, the N,N-dimethylamine product will take longer than 18 days to reverse back to formaldehyde bisulfite adduct (CAS 870-72-4) (i.e., only 3.5% conversion at 18 days), which can then reverse back to formaldehyde.

### Example 3

Use of sodium bisulfite and N,N-dimethylamine to neutralize formaldehyde in an insecticidal formulation.

Initially, bio-enumeration was conducted as evidence for neutralization. Briefly, various formaldehyde scavengers were combined with CropStar®. These mixtures were added to Rhizobium inoculums and colony growth was determined by use of a colony counter. These data are shown below in Table 2.

TABLE 2

| | | Approx. | | |
|---|---|---|---|---|
| Sample | | colonies/ | Approx. | |
| # | Sample Description | plate | CFU/mL | pH |
| 1 | Unaltered CropStar ® | 0 | 0.00E+00 | 4.9 |
| 2 | CropStar ® + sodium bisulfite | 157 | 4.66E+05 | 4.7 |
| | 1 Mol eq | | | |
| 3 | CropStar ® + sodium bisulfite | 396 | 1.18E+06 | 5.3 |
| | 1 Mol eq + dimethyl amine | | | |
| | 1 Mol eq after 15 min | | | |
| 4 | CropStar ® + sodium bisulfite | 203 | 6.03E+05 | 5.6 |
| | 1 Mol eq + dimethyl amine | | | |
| | 1 Mol eq | | | |
| 5 | CropStar ® formulation minus | 139 | 4.13E+05 | 5.1 |
| | formaldehyde | | | |
| 6 | Inoculum only | 1793 | 5.33E+06 | 7.2 |

Subsequently, HPLC was used to determine stability of the active ingredients within CropStar® (i.e., thiodicarb and imidacloprid).

TABLE 3

| | | | Methomyl | Imidacloprid | Thiodicarb | Thiodicarb/ |
|---|---|---|---|---|---|---|
| Sample | Condition | | wt. % | wt. % | wt. % | Imidacloprid |
| CropStar ® alone | control | | 0.16 | 12.37 | 36.32 | 2.94 |
| CropStar ® + inoculum | 0 | h | 0.14 | 8.52 | 25.03 | 2.94 |
| | 24 | h | 0.11 | 8.58 | 25.15 | 2.93 |
| CropStar ® + Safener | 0 | h | 0.13 | 7.66 | 22.35 | 2.92 |
| 1 + inoculum | 24 | h | 0.13 | 7.64 | 22.29 | 2.92 |
| CropStar ® + Safener | 0 | h | 0.15 | 6.92 | 20.11 | 2.91 |
| 2, pH adjusted | 24 | h | 0.14 | 6.76 | 19.31 | 2.86 |
| (pH = 7) + inoculum | | | | | | |
| CropStar ® + sodium | 0 | h | 0.27 | 8.34 | 24.34 | 2.92 |
| bisulfite + dimethyl | 24 | h | 0.21 | 8.42 | 24.58 | 2.92 |
| amine, pH adjusted | | | | | | |
| (pH = 7) + inoculum | | | | | | |
| CropStar ® + inoculum, | 0 | h | 0.17 | 8.41 | 24.71 | 2.94 |
| pH adjusted | 24 | h | 0.15 | 8.49 | 24.92 | 2.93 |
| (pH = 7) | | | | | | |

As demonstrated by the data in Table 3, 1 molar equivalent of sodium bisulfite+dimethyl amine did not significantly degrade thiodicarb or imidacloprid within a 24-hour period.

Addition of sodium bisulfite, followed by addition of N,N-dimethylamine or addition of sodium bisulfite concurrently with N,N-dimethylamine performed well in terms of retaining biocide activity and insecticide integrity. Both insecticide actives, thiodicarb and imidacloprid, remained stable and activity of the Rhizobium inoculant was retained.

This method demonstrates that safeners, such as the combination of sodium bisulfite and N,N-dimethylamine, can neutralize formaldehyde for a longer duration of time. The formed adduct is stable in an aqueous solution for longer than 18 days as determined by C-13 NMR.

All references cited in this specification are herein incorporated by reference as though each reference was specifically and individually indicated to be incorporated by reference. The citation of any reference is for its disclosure prior to the filing date and should not be construed as an admission that the present disclosure is not entitled to antedate such reference by virtue of prior invention.

It will be understood that each of the elements described above, or two or more together may also find a useful application in other types of methods differing from the type described above. Without further analysis, the foregoing will so fully reveal the gist of the present disclosure that others can, by applying current knowledge, readily adapt it for various applications without omitting features that, from the standpoint of prior art, fairly constitute essential characteristics of the generic or specific aspects of this disclosure set forth in the appended claims. The foregoing embodiments are presented by way of example only; the scope of the present disclosure is to be limited only by the following claims.
(Original) A safener comprising at least one sulfite and at least one amine.

2. The safener according to claim 1, wherein the at least one sulfite is sodium bisulfite.

3. The safener according to claim 1, wherein the at least one amine is N,N-dimethylamine.

4. A formulation comprising at least one pesticide, at least one biocide, and a safener that reduces the toxicity of the biocide.

5. The formulation according to claim 4, wherein the pesticide contains one or more thio-N carbamoyl functional groups.

6. The formulation according to claim 4, wherein the pesticide is thiodicarb, imidacloprid, or a combination thereof. (Currently Amended) The formulation according to claim 4, wherein the biocide is formaldehyde and/or a formaldehyde-releasing compound.

8. The formulation according to claim 4, wherein the biocide is isothiazolinone or a derivative thereof.

9. The formulation according to claim 8, wherein the biocide is an isothiazoline derivative and is selected from the group consisting of:
methylisothiazolinone, chloromethylisothiazolinone, benzisothiazolinone, octylisothiazolinone, dichlorooctylisothiazolinone, and butylbenzisothiazolinone.

10. The formulation according to claim 4, wherein the safener comprises at least one sulfite.

11. The formulation according to claim 10, wherein the sulfite is sodium bisulfite.

12. The formulation according to claim 10, wherein the safener further comprises an amine.

13. The formulation according to claim 12, wherein the amine is N,N-dimethylamine.

14. The formulation according to claim 4, wherein the safener is present in an amount sufficient to neutralize the biocide.

15. The formulation according to claim 4, wherein the safener and the biocide is present in a mole ratio from about 5:1 to about 1:5.

16. The formulation according to claim 4, wherein the safener and the biocide is present in a mole ratio of about 1:1.

17. The formulation according to claim 4, further comprising a microbial inoculant.

18. The formulation according to claim 17, wherein the microbial inoculant is Rhizobium.

19. A spray formulation comprising the formulation of claim 4 or a safener comprising at least one sulfite and at least one amine.

20. A seed treated with the formulation of claim 4 or a safener comprising at least one sulfite and at least one amine.

21. A method for co-application of a pesticide and a microbial inoculant comprising applying a formulation of claim 4 to a seed, a plant, and/or to soil wherein a plant is growing or wherein a plant is desired to grow.

22. A method for treating a plant comprising:
a) providing at least one pesticide formulation, at least one biocide, at least one safener, and at least one microbial inoculant; and
b) applying the at least one pesticide formulation, at least one biocide, at least one safener and at least one microbial inoculant to the plant.

23. The method of claim 22, wherein the at least one pesticide formulation, at least one biocide, at least one safener and at least one microbial inoculant is applied to soil, a seed, fruit, and/or a plant or a portion thereof.

24. The method of claim 22, wherein one or more of the at least one pesticide formulation, at least one biocide, at least one safener and at least one microbial inoculant are mixed prior to applying to the plant.

25. The method of claim 22, wherein one or more of the at least one pesticide formulation, at least one biocide, at least one safener and at least one microbial inoculant are provided in a single formulation.

26. The method of claim 22, wherein one or more of the at least one pesticide formulation, at least one biocide, safener and at least one microbial inoculant are applied to the plant separately.

27. The method of claim 22, wherein the safener is applied to the plant concurrently with the biocide.

28. The method of claim 22, wherein the pesticide formulation comprises a thio-N carbamoyl functional group.

29. The method of claim 22, wherein the pesticide is thiodicarb, imidacloprid, or a combination thereof.

30. The method of claim 22, wherein the biocide is formaldehyde and/or a formaldehyde-releasing compound.

31. The method of claim 22, wherein the biocide is isothiazolinone or a derivative thereof.

32. The method of claim 22, wherein the safener comprises a sulfite.

33. The method of claim 32, wherein the sulfite is sodium bisulfite.

34. The method of claim 32, wherein the safener further comprises an amine.

35. The method of claim 34, wherein the amine is N,N-dimethylamine.

36. The method of claim 22, wherein the microbial inoculant is Rhizobium.

37. The method of claim 22, wherein the plant is a legume.

38. The method of claim 37, wherein the legume is selected from the group consisting of: a grain legume such as a bean, a lentil, a lupin, a pea, a peanut, and a soybean, American groundnut, azuki bean, black bean, black-eyed pea, chickpea (garbanzo bean), drumstick, dolichos bean, fava bean (broad bean), French bean, guar, haricot bean, horse gram, Indian pea, kidney bean, lentil, lima bean, moth bean, mung bean, navy bean, okra, pea, peanut (groundnut), pigeon pea, pinto bean, rice bean, runner bean, soybean, tarwi, tepary bean, urad bean, velvet bean, winged bean, yardlong bean, an Indigofera spp, an Acacia spp, pink beans, green baby lima, chickpea café type, dark red kidney beans, black beans, small red beans, cranberry beans, great northern bean small red, milky white, pedrosillano, athena, beluga, crimson, crimson decorticated, eston, French green, pardina, red chief, red chief decorticated, richle, a large green, regular, Austrian winter, whole green, green split, marrowfat, whole yellow, yellow split, a forage legumes, such as alfalfa, alsike clover, arrowleaf clover, berseem clover, birdsfoot trefoil, cicer milkvetch, crimson clover, hairy vetch, kura clover, ladino clover, mammoth red clover, medium red clover, sainfoin, strawberry clover, white clover, and yellow blossom sweet clover, a fallow/green manure legume species such as, Leucaena, Cyamopsis, and Sesbania, and Castanospermum australe.

39. The safener according to claim 1 for neutralizing and/or reducing toxicity of a biocide in a pesticidal formulation.

40. The formulation according to claim 4 for treating a plant or a part thereof.
